(19) United States
(12) Patent Application Publication
(10) Pub. No.: US 2019/0339993 A1
(43) Pub. Date: Nov. 7, 2019

(54) RECORDING MEDIUM RECORDING PROGRAM USE ASSISTING PROGRAM AND INFORMATION PROCESSING APPARATUS

(71) Applicant: FUJITSU LIMITED, Kawasaki-shi (JP)

(72) Inventors: Tomohiko Maeda, Setagaya (JP); Shusaku Nishiyama, Yokohama (JP); Toshikazu Furui, Kawasaki (JP)

(73) Assignee: FUJITSU LIMITED, Kawasaki-shi (JP)

(21) Appl. No.: 16/512,871

(22) Filed: Jul. 16, 2019

Related U.S. Application Data
(63) Continuation of application No. PCT/JP2017/002255, filed on Jan. 24, 2017.

(51) Int. Cl. G06F 9/445; G06F 9/451

(52) U.S. Cl. CPC G06F 9/44505; G06F 9/453

(57) ABSTRACT

A non-transitory computer-readable recording medium stores therein a program use assisting program for causing a computer to execute processing including: acquiring data items included in production management data; referring to a storage that stores a data item which is used when each of a plurality of production assisting programs is executed; specifying a production assisting program of which all data items which are used at the time of execution are included in the acquired data items from among the plurality of production assisting programs as a specific program; and outputting information indicating the specific program.

### CROSS-REFERENCE TO RELATED APPLICATION

This application is a continuation application of International Application PCT/JP2017/002255 filed on Jan. 24, 2017 and designated the U.S., the entire contents of which are incorporated herein by reference.

### FIELD

The embodiments discussed herein are related to a recording medium recording a program use assisting program, an information processing apparatus, and a program use assisting method.

### BACKGROUND

An administrator of a factory improves a production efficiency and performs production forecast based on various production management data collected from production equipment in operation.

Japanese Laid-open Patent Publication No. 2016-66137 and Japanese Laid-open Patent Publication No. 2010-218064 are disclosed as related art.

### SUMMARY

According to an aspect of the embodiments, a non-transitory computer-readable recording medium stores therein a program use assisting program for causing a computer to execute processing including: acquiring data items included in production management data; referring to a storage that stores a data item which is used when each of a plurality of production assisting programs is executed; specifying a production assisting program of which all data items which are used at the time of execution are included in the acquired data items from among the plurality of production assisting programs as a specific program; and outputting information indicating the specific program.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an exemplary configuration and exemplary processing of a program use assisting device according to a first embodiment;

FIG. 2 is a diagram illustrating an exemplary configuration of a production assisting system according to a second embodiment;

FIG. 3 is a diagram illustrating an exemplary hardware configuration of a production assisting server;

FIG. 4 is a block diagram illustrating an exemplary configuration of a processing function of a production management server;

FIG. 5 is a diagram illustrating an exemplary data configuration of a production management database accumulated in the production management server;

FIG. 6 is a block diagram illustrating an exemplary configuration of a processing function of a data accumulation server;

FIG. 7 is a diagram illustrating an exemplary data configuration of the production management database accumulated in the data accumulation server;

FIG. 8 is a block diagram illustrating an exemplary configuration of a processing function of the production assisting server;

FIG. 9 is a diagram illustrating an exemplary data configuration of a user management database;

FIG. 10 is a diagram illustrating an exemplary data configuration of an application management database;

FIG. 11 is a diagram (part 1) illustrating exemplary processing by a production assisting program for visualizing progress results of a production process;

FIG. 12 is a diagram (part 2) illustrating exemplary processing by the production assisting program for visualizing the progress results of the production process;

FIG. 13 is a diagram (part 1) illustrating exemplary processing by the production assisting program for visualizing a change in a production quantity per unit time;

FIG. 14 is a diagram (part 2) illustrating exemplary processing by the production assisting program for visualizing the change in the production quantity per unit time;

FIGS. 15A and 15B are diagrams illustrating exemplary processing by the production assisting program for correcting a displacement in a component mounting position;

FIG. 16 is a diagram illustrating an example of an alternative item;

FIG. 17 is a flowchart illustrating first exemplary processing in a use assisting service;

FIGS. 18A to 18D are diagrams illustrating exemplary screen displays of a terminal device in the first exemplary processing;

FIG. 19 is a flowchart illustrating second exemplary processing in the use assisting service;

FIG. 20 is a diagram illustrating an exemplary screen display of a terminal device in the second exemplary processing;

FIG. 21 is a diagram illustrating an exemplary configuration of a processing function of a production assisting server according to a third embodiment;

FIG. 22 is a flowchart illustrating exemplary processing in a production assisting service;

FIG. 23 is a diagram illustrating an exemplary configuration of a processing function of a production assisting server according to a fourth embodiment;

FIG. 24 is a flowchart illustrating exemplary processing in a developer assisting service; and

FIG. 25 is a diagram illustrating an exemplary screen display of a developer terminal by the developer assisting service.

### DESCRIPTION OF EMBODIMENTS

For example, application programs for assisting such works by the administrator have been used. Execution of the application program provides information useful for the improvement in the efficiency and the production forecast to the administrator based on the production management data.

A diagnosis assisting device may be proposed which outputs a data range recommended as a range of input data calculated by a diagnosis assisting program. An information processing device may be proposed which searches service attribute information regarding a type which coincides with a type of a service designated in a use request and determines a service of which use is recommended based on evaluation information included in the searched service attribute information.

By the way, as described above, at the time when the application program for assisting the work of the administrator of the factory is executed, the production management data collected from the production equipment is referred. Since the production management data is data dependent on the production equipment, it is desirable to select the application program used by the administrator which matches a state of the production equipment. However, an optimal application program which matches the state of the production equipment of the administrator may not be necessarily selected.

For example, a program use assisting program, a program use assisting device, and a program use assisting method capable of specifying an appropriate production assisting program suitable for production equipment may be provided.

Hereinafter, embodiments of the present invention are described with reference to the drawings.

### First Embodiment

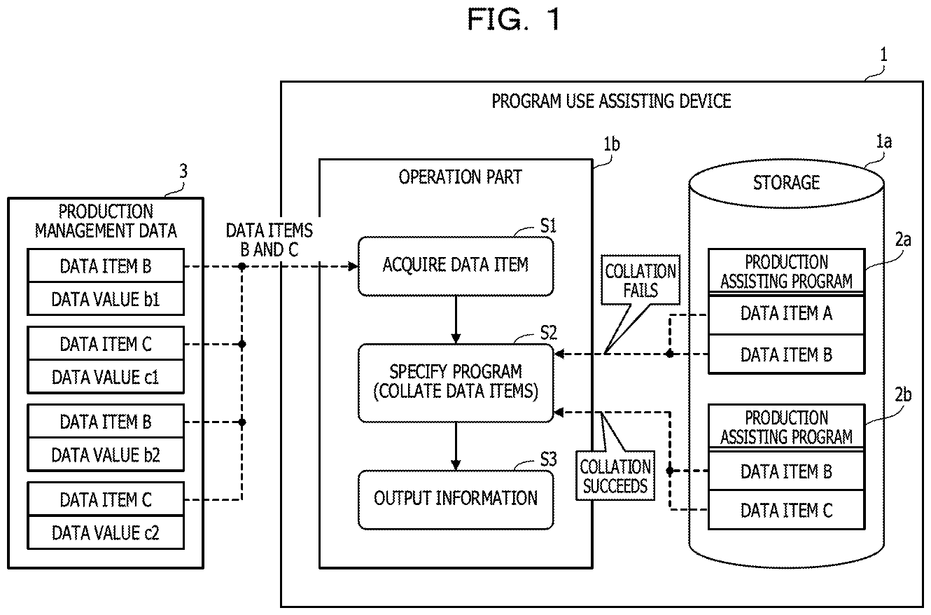

FIG. 1 is a diagram illustrating an exemplary configuration and exemplary processing of a program use assisting device according to a first embodiment. A program use assisting device 1 executes processing for assisting use of a production assisting program by a user. The user is, for example, an administrator of a factory that produces products such as industrial products, parts, foods, plants, and the like and a planner of a production plan. The production assisting program is used by the user so as to provide various assistance regarding the production such as management of a production process, a work for facilitating efficiency in the production, production forecast, planning of production plans based on the forecast, and the like to the user.

The program use assisting device 1 includes a storage 1a and an operation part 1b. The storage 1a is realized, for example, as a storage region of a storage device included in the program use assisting device 1. The operation part 1b is realized, for example, as a processor included in the program use assisting device 1. In this case, the processor executes a predetermined program so as to implement processing by the operation part 1b.

The storage 1a stores a data item used at the time when each of a plurality of production assisting programs is executed. The data item is an item included in production management data. The production management data includes at least one or more pairs of the data item and a data value corresponding to the data item. The production management data is, for example, data acquired along with an operation of the factory of the user. In this case, the data item included in the production management data is different depending on a state of production equipment in the factory where the production management data is acquired.

In the example in FIG. 1, the storage 1a stores data items A and B for a production assisting program 2a and stores data items B and C for a production assisting program 2b. In this case, at least data values corresponding to the data items A and B are referred at the time when the production assisting program 2a is executed, and at least data values corresponding to the data items B and C are referred at the time when the production assisting program 2b is executed.

The operation part 1b executes the following processing. The operation part 1b acquires a data item included in production management data 3 (step S1). The production management data 3 to be acquired is data corresponding to a user who performs use assistance. In the example in FIG. 1, the production management data 3 includes data values b1 and b2 corresponding to the data item B and data values c1 and c2 corresponding to the data item C. In this case, the operation part 1b acquires the data items B and C from the production management data 3.

Next, the operation part 1b refers to the storage 1a and specifies a production assisting program in which the data items acquired from the production management data 3 include all data items used at the time when the production management data 3 is executed, between the production assisting programs 2a and 2b (step S2). For example, in this processing, the data item acquired from the production management data 3 is collated with the data item for each production assisting program stored in the storage 1a.

In the example in FIG. 1, the data items B and C acquired from the production management data 3 do not include the data item A of the data items A and B associated with the production assisting program 2a. Therefore, the operation part 1b determines that the collation with respect to the production assisting program 2a has failed. In this case, since the data value of the data item A which is referred when the production assisting program 2a is executed lacks, the user is not capable of using the production assisting program 2a.

On the other hand, the data items B and C acquired from the production management data 3 include both the data items B and C associated with the production assisting program 2b. Therefore, the operation part 1b determines that the collation with respect to the production assisting program 2b has succeeded. For example, in step S2, the operation part 1b specifies the production assisting program 2b. In this case, it is determined that the user can use the production assisting program 2b.

Next, the operation part 1b outputs information indicating the production assisting program 2b specified in step S2 (step S3). With this output, it is possible to notify the user that the production assisting program 2b can be used according to the data value of the data item that is currently acquired.

According to the above processing, the program use assisting device 1 can specify an appropriate production assisting program that is suitable for the state of the production equipment of the user side. Therefore, by notifying the user of the information indicating the specified production assisting program, it is possible to appropriately assist to use the production assisting program by the user. The user uses the specified production assisting program so as to, for example, promote efficiency in various works regarding production.

### Second Embodiment

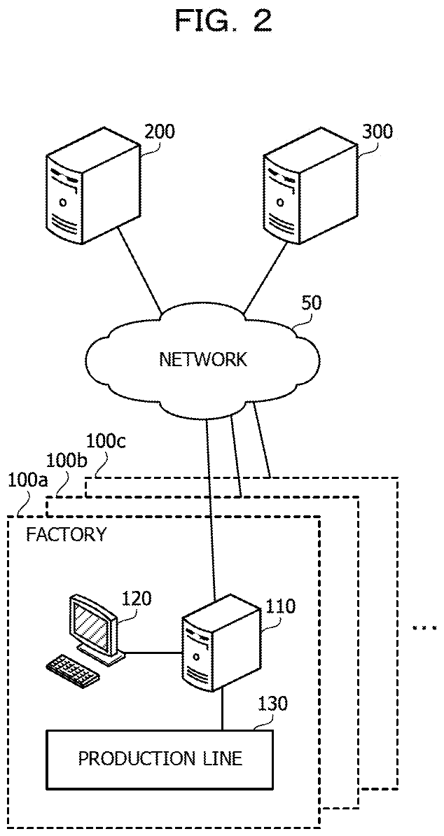

FIG. 2 is a diagram illustrating an exemplary configuration of a production assisting system according to a second embodiment. The production assisting system illustrated in FIG. 2 is a system, in which a company or an organization having a factory is assumed as a user, for providing a service for assisting a production activity in the factory by the user. In FIG. 2, as an example, factories 100a, 100b, 100c, . . . respectively corresponding to individual users are illustrated. For example, each of the factories 100a, 100b, 100c, . . . may be a factory for manufacturing various industrial products and parts and may be a factory for producing plants, agricultural products, and foods.

Each of the factories 100a, 100b, 100c, . . . includes a production management server 110, a terminal device 120, and a production line 130. The production management server 110 in each of the factories 100a, 100b, 100c, . . . is connected to a data accumulation server 200 and a production assisting server 300 via a network 50. The data accumulation server 200 and the production assisting server 300 can communicate with each other via the network 50.

The production management server 110 manages production progress in the production line 130 according to data indicating a production plan. At this time, the production management server 110 accumulates various data measured along with production in a production management database. In the following description, there is a case where the data accumulated in the production management database is described as “production management data”. The production management data includes at least a pair of a measurement item and a measurement value of the measurement item and indicates, for example, a production progress state, a state of a manufacturing machine, and the like.

The production management server 110 has a function for making the user receive a production assisting service provided from the production assisting server 300. The production assisting service is a service for assisting the production activity of the user, and may include, for example, services for visualizing the production state, providing statistical information in the production activity, indicating problems and improvements in the production activity, adjusting the production equipment, and the like. The production assisting service is implemented by an application program provided from the production assisting server 300. Hereinafter, this application program is referred to as a “production assisting program”.

In the present embodiment, as an example, the production assisting program is executed by the production assisting server 300, and the processing result is provided to the production management server 110. A production manager and a production planner of the factory instruct the production assisting server 300 to execute the production assisting program via the production management server 110 by using the terminal device 120 and recognize the processing result via a display device of the terminal device 120 and the like.

The production management server 110 can receive the use assisting service for assisting the use of the production assisting program from the production assisting server 300. The use assisting service includes, for example, a service which notifies the user which production assisting program can be provided by using the production management data accumulated by the user and recommends to use the notified program. The production management server 110 has a function for uploading the production management data accumulated in the production management server 110 to the data accumulation server 200 so as to receive the use assisting service.

The terminal device 120 is connected to the production management server 110, and an operator on the user side such as a production manager and a production planner operates the terminal device 120. The operator can receive the production assisting service and the use assisting service of the production assisting program via the terminal device 120.

The production line 130 produces products under control of the production management server 110. The production line 130 includes, for example, various sensors and transmits detected values detected by the sensors in a production process to the production management server 110. The production line 130 is merely an example of the production equipment provided in the factory. The factory that can receive the production assisting service according to the present embodiment is not limited to a factory which adopts a line production system.

The data accumulation server 200 collects production management data accumulated in each of the factories 100a, 100b, 100c, . . . and accumulates the production management data in a database. The data accumulation server 200 provides the production management data accumulated in the database in response to a request from the production assisting server 300.

The data accumulation server 200 may be, for example, a server which provides a platform which is used for making various service providers use production management data collected from a large number of factories. In this case, the data accumulation server 200 has an authentication function for connecting to the production management server 110 in each factory which is a data collection source and a server on the side of the service provider. The production assisting server 300 is positioned as one of servers of the service providers.

The production assisting server 300 provides the production assisting service to the user by executing the production assisting program. For example, the production assisting server 300 acquires the production management data collected from the user from the data accumulation server 200. The production assisting server 300 executes the production assisting program, for which an offer for providing the program is applied by the user, by using the acquired production management data and transmits the processing result to the production management server 110 of the user.

The production assisting server 300 provides the use assisting service of the production assisting program to the user. For example, the production assisting server 300 provides the following service to a user who has not received the production assisting service yet. The production assisting server 300 selects a production assisting program to be recommended to the user. The production assisting server 300 acquires the production management data collected from the user from the data accumulation server 200. The production assisting server 300 determines whether data needed for executing the selected production assisting program has been measured in the production management server 110 of the user based on the content of the acquired production management data.

In a case where the data has been measured, the production assisting server 300 notifies the user that the selected production assisting program is available. On the other hand, in a case where there is data insufficient for using the selected production assisting program, the production assisting server 300 notifies the user of an item of the insufficient data and guides the user that a new production assisting program will be available by acquiring the data of the notified item.

In this way, the production assisting server 300 can guide the available production assisting program to the user by using the measurement item measured by the production management server 110 of the user and can recommend to use the production assisting program. The production assisting server 300 can guide the production assisting program that can be used by increasing the measurement items together with the measurement items to be increased to the user and can recommend to use the production assisting program. The production assisting server 300 can recommend to use another production assisting program to a user who has already used the production assisting program.

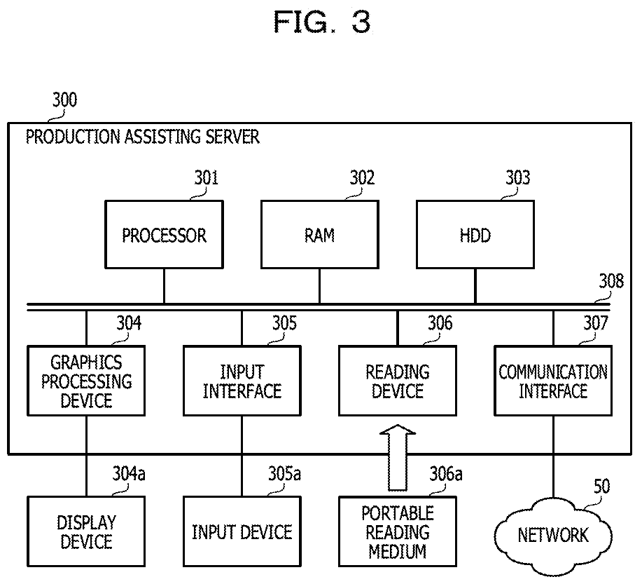

FIG. 3 is a diagram illustrating an exemplary hardware configuration of the production assisting server. The production assisting server 300 according to the second embodiment is realized, for example, as a computer as illustrated in FIG. 3.

The entire production assisting server 300 is controlled by a processor 301. The processor 301 may be a multiprocessor. The processor 301 is, for example, a central processing unit (CPU), a micro processing unit (MPU), a digital signal processor (DSP), an application specific integrated circuit (ASIC), or a programmable logic device (PLD). The processor 301 may be a combination of two or more elements of the CPU, the MPU, the DSP, the ASIC, and the PLD.

A random access memory (RAM) 302 and a plurality of peripheral devices are connected to the processor 301 via a bus 308.

The RAM 302 is used as a main storage device of the production assisting server 300. The RAM 302 temporarily stores at least a part of an operating system (OS) program and an application program to be executed by the processor 301. The RAM 302 stores various data needed for processing by the processor 301.

The peripheral devices connected to the bus 308 include a hard disk drive (HDD) 303, a graphic processing device 304, an input interface 305, a reading device 306, and a communication interface 307.

The HDD 303 is used as an auxiliary storage device of the production assisting server 300. The HDD 303 stores the OS program, the application program, and various data. Other kind of non-volatile storage device such as a solid state drive (SSD) can be used as the auxiliary storage device.

The graphic processing device 304 is connected to a display device 304a. The graphic processing device 304 makes the display device 304a display an image according to a command from the processor 301. As the display device 304a, a liquid crystal display, an organic electroluminescence (EL) display, and the like are used.

The input interface 305 is connected to an input device 305a. The input interface 305 transmits a signal output from the input device 305a to the processor 301. The input device 305a includes a keyboard, a pointing device, and the like. The pointing device includes a mouse, a touch panel, a tablet, a touch pad, a trackball, and the like.

A portable reading medium 306a is attached to and detached from the reading device 306. The reading device 306 reads data recorded in the portable reading medium 306a and transmits the data to the processor 301. The portable reading medium 306a include an optical disk, a magneto-optical disk, a semiconductor memory, and the like.

The communication interface 307 exchanges data with other devices such as the production management server 110, the data accumulation server 200, and the like via the network 50.

The processing function of the production assisting server 300 can be implemented by the hardware configuration described above. The production management server 110 and the data accumulation server 200 can be realized as the computer as illustrated in FIG. 3.

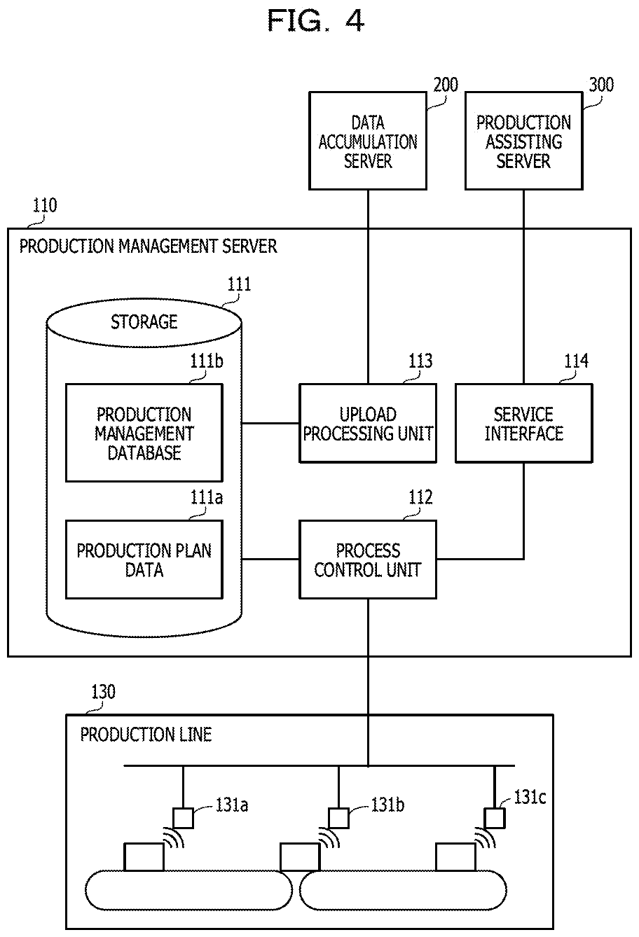

FIG. 4 is a block diagram illustrating an exemplary configuration of a processing function of the production management server. The production management server 110 includes a storage 111, a process control unit 112, an upload processing unit 113, and a service interface 114. The storage 111 is implemented, for example, as a storage region of a storage device provided in the production management server 110. Processing of the process control unit 112, the upload processing unit 113, and the service interface 114 is realized, for example, by executing a predetermined program by a processor of the production management server 110.

The storage 111 stores production plan data 111a and a production management database 111b. The production plan data 111a is data used for controlling progress in a production process in the production line 130. The production management database 111b accumulates production management data acquired from the production line 130. At least one of the production plan data 111a and the production management database 111b may be stored in a storage device connected to the outside of the production management server 110.

The process control unit 112 controls the progress in the production process in the production line 130 based on the production plan data 111a. The process control unit 112 acquires the production management data from the production line 130 and accumulates the production management data in the production management database 111b. As described above, the production management data is data measured along with production.

For example, as illustrated in FIG. 4, sensors 131a, 131b, 131c, . . . for detecting the production progress state and the state of the manufacturing machine are provided in the production line 130. The process control unit 112 acquires detection data from the sensors 131a, 131b, 131c, . . . , controls the progress in the process based on the acquired detection data, and stores the acquired detection data in the production management database 111b as the production management data. Such detection data includes, for example, a temperature detected by a temperature sensor, a current in the device, a value of a voltage, a count value indicating the number of times of detection by a proximity sensor and a light cutting sensor, a reading result and a reading time of a barcode attached to a product or a component conveyed on the production line 130, and the like.

The process control unit 112 can perform predetermined calculation based on the detection data acquired from the production line 130 and can store the calculation result in the production management database 111b as the production management data. For example, the process control unit 112 can calculate the number of products and the number of defects per hour in a manufacturing process based on a completion time of a manufacturing process of a certain product and store the calculated results in the production management database 111b. Alternatively, the process control unit 112 can calculate a position displacement amount and variation of a mount position based on a mount position detection result of a product in a certain manufacturing process and store the calculation results in the production management database 111b.

In this way, the production management database 111b in each factory accumulates the detection data acquired from the production line 130 and the data calculated from the detection data. In the following description, a value of the detection data detected from the sensor in this way and a value calculated from the value of the detection data are described as a “measurement value”.

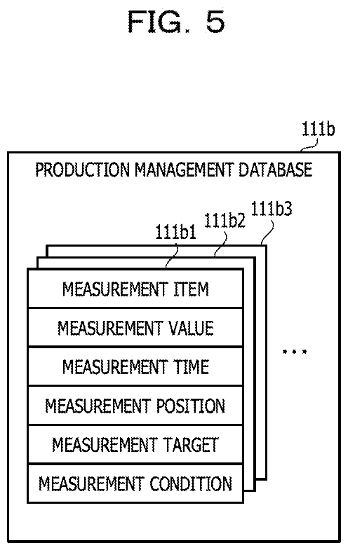

FIG. 5 is a diagram illustrating an exemplary data configuration of a production management database accumulated in a production management server. In each of records 111b1, 111b2, 111b3, . . . of the production management database 111b, a measurement item, a measurement value, a measurement time, a measurement position, a measurement target, and a measurement condition are registered.

The measurement item indicates what kind of information the measurement value is. The measurement value is a value corresponding to the measurement item and indicates, for example, the detected value by the sensor of the production line 130 or the value calculated based on the detected value. The measurement time indicates a time when the measurement value is measured. The measurement position indicates a position on the production line 130 where the measurement value is measured and a process in which the measurement value is measured. In a case where the plurality of production lines 130 exists in the same factory, the measurement position may indicate identification information of the production line 130. The measurement target indicates information for identifying a product of which the measurement value is measured. For example, the measurement target indicates an ID, a lot number, an order number, and the like of the product. The measurement condition indicates a condition under which the measurement value is measured. For example, the measurement condition indicates a sampling period (acquisition frequency) of the measurement value, a resolution of the measurement value, and the like.

Hereinafter, returning to FIG. 4, and the description is continued.

The upload processing unit 113 uploads the production management data accumulated in the production management database 111b to the data accumulation server 200. At this time, the upload processing unit 113, for example, converts the accumulated production management data into data in a predetermined format and uploads the converted data to the data accumulation server 200. For example, the production management data is converted into data in an extensible markup language (XML) format in which a pair of tag information and the data value is described as text data or the JavaScript object notation (JSON, JavaScript: registered trademark).

The service interface 114 executes processing for receiving the production assisting service and the use assisting service of the production assisting program from the production assisting server 300. For example, the production assisting server 300 functions as a Web server for providing these services. In this case, in the terminal device 120 connected to the production management server 110, a Web browser is operated, and the service interface 114 relays data exchanged between the production assisting server 300 and the Web browser of the terminal device 120. For example, the service interface 114 receives data of a Web page indicating the processing result of each of the above services from the production assisting server 300 and transmits the received data to the terminal device 120. With this operation, the processing result of the service is displayed on the Web browser. For example, based on the data transmitted from the production assisting server 300 according to the processing of the production assisting program, the service interface 114 can change control processing and setting of the production line 130 by the process control unit 112.

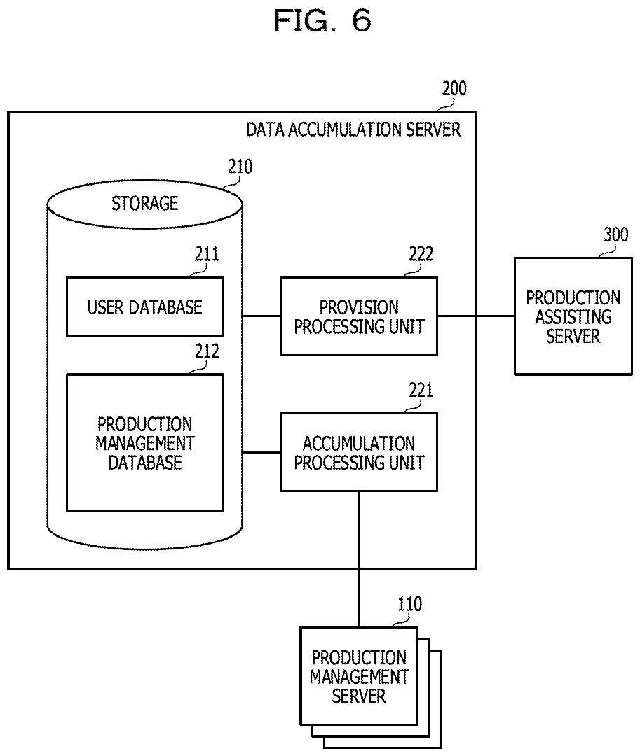

FIG. 6 is a block diagram illustrating an exemplary configuration of a processing function of a data accumulation server. The data accumulation server 200 includes a storage 210, an accumulation processing unit 221, and a provision processing unit 222. The storage 210 is implemented, for example, as a storage region of a storage device provided in the data accumulation server 200. Processing of the accumulation processing unit 221 and the provision processing unit 222 is realized, for example, by executing a predetermined program by a processor of the data accumulation server 200.

The storage 210 stores a user database 211 and a production management database 212. The user database 211 stores information for performing user authentication. The user here includes a user who can acquire the production management data accumulated in the data accumulation server 200, in addition to a user who receives the production assisting service from the production assisting server 300. For example, the user database 211 stores information used for user authentication when the production management data is uploaded from the production management server 110 and information used for user authentication when the production management data is requested from the production assisting server 300. The production management data collected from the production management server 110 in each factory is accumulated in the production management database 212.

At least one of the user database 211 and the production management database 212 may be stored in a storage device connected to the outside of the data accumulation server 200.

The accumulation processing unit 221 stores the production management data uploaded from the production management server 110 in each factory in the production management database 212. With this operation, in the production management database 212 of the data accumulation server 200, the production management data locally accumulated in each factory is intensively collected. The accumulation processing unit 221 refers to the user database 211 when being connected to each production management server 110.

The provision processing unit 222 reads the production management data requested from the production assisting server 300 from the production management database 212 and transmits the read data to the production assisting server 300. For example, the provision processing unit 222 can receive a search key such as a user name, a measurement period, and the like from the production assisting server 300, extract production management data corresponding to the search key from the production management database 212, and transmit the production management data to the production assisting server 300.

The provision processing unit 222 refers to the user database 211 when being connected to the production assisting server 300. The user database 211 can limit the production management data that can be acquired by the production assisting server 300 for each user and can limit a range of data that can be acquired.

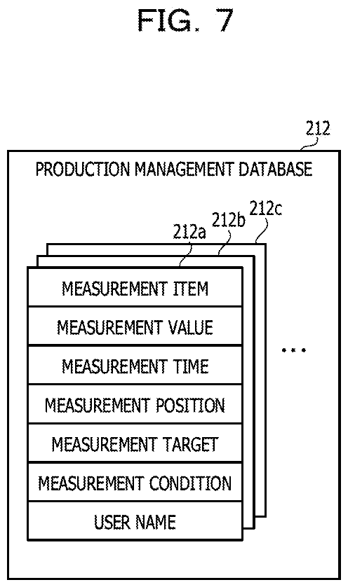

FIG. 7 is a diagram illustrating an exemplary data configuration of a production management database accumulated in the data accumulation server. In each of records 212a, 212b, 212c, . . . of the production management database 212, a user name is registered in addition to the data included in each record of the production management database 111b accumulated in each factory. The user name indicates a user who has transmitted the data in the record.

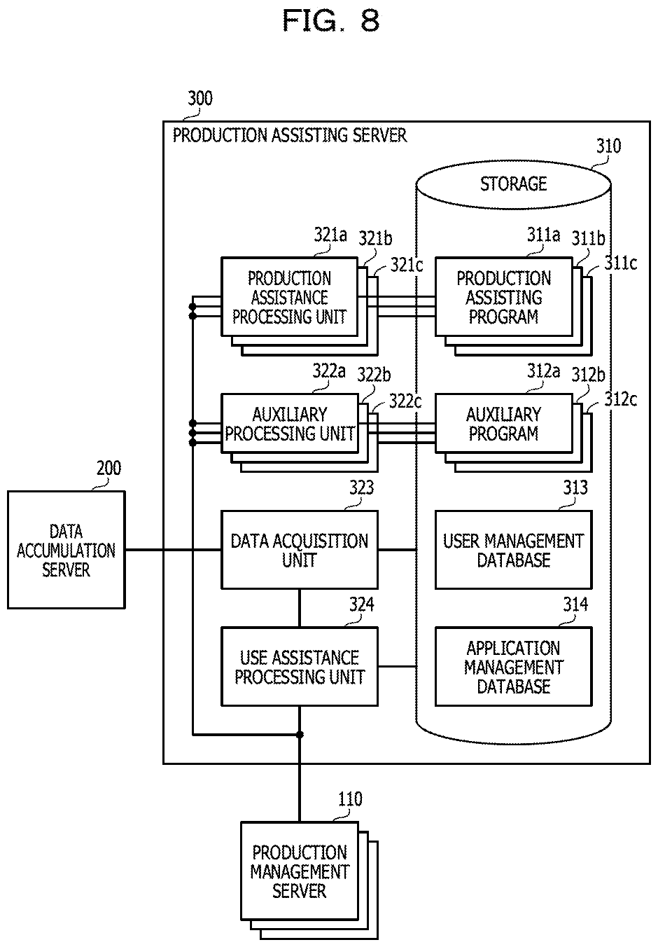

FIG. 8 is a block diagram illustrating an exemplary configuration of a processing function of the production assisting server. The production assisting server 300 includes a storage 310, production assistance processing units 321a, 321b, 321c, . . . , auxiliary processing units 322a, 322b, 322c, . . . , a data acquisition unit 323, and a use assistance processing unit 324.

The storage 310 is implemented as a storage region of a storage device provided in the production assisting server 300, for example, the HDD 303 illustrated in FIG. 3 and the like. The storage 310 stores production assisting programs 311a, 311b, 311c, . . . , auxiliary programs 312a, 312b, 312c, . . . , a user management database 313, and an application management database 314.

The production assisting programs 311a, 311b, 311c, . . . are application programs for providing the production assisting service. The auxiliary programs 312a, 312b, 312c, . . . are application programs for executing processing for assisting processing by the production assisting program. The auxiliary processing includes, for example, processing for creating production management data needed for using the production assisting program by using other production management data having different measurement items.

In the user management database 313, a user who receives the production assisting service and the production assisting program used by the user are registered in association with each other. In the application management database 314, information regarding each of the production assisting programs 311a, 311b, 311c, . . . is registered. For example, in the application management database 314, a measurement item of production management information used (for example, referred) at the time when the production assisting program is executed is registered.

Processing of the production assistance processing units 321a, 321b, 321c, . . . is realized by executing the respective production assisting programs 311a, 311b, 311c, . . . by the processor 301 of the production assisting server 300. For example, the production assistance processing units 321a, 321b, 321c, . . . are activated by executing the respective production assisting programs 311a, 311b, 311c, . . . by the processor 301.

For example, when providing a production assisting service to a certain user, the production assistance processing unit 321a acquires the production management data corresponding to the user from the data accumulation server 200 via the data acquisition unit 323. The production assistance processing unit 321a executes the processing for assisting the production activity of the user by using the acquired production management data and transmits the processing result to the production management server 110 corresponding to the user.

Processing of the auxiliary processing units 322a, 322b, 322c, . . . is realized by executing the respective auxiliary programs 312a, 312b, 312c, . . . by the processor 301 of the production assisting server 300. For example, the auxiliary processing units 322a, 322b, 322c, . . . are activated by executing the respective auxiliary programs 312a, 312b, 312c, . . . by the processor 301.

Processing of the data acquisition unit 323 and the use assistance processing unit 324 is realized by executing a predetermined program by the processor 301 of the production assisting server 300, for example.

The data acquisition unit 323 acquires production management data needed for execution of the production assisting program from the data accumulation server 200. For example, the data acquisition unit 323 transmits the search key such as the user name, the measurement period, and the like to the data accumulation server 200 to request a search so as to acquire data of a record corresponding to the search key from the production management database 212 of the data accumulation server 200.

The use assistance processing unit 324 executes processing for providing the use assisting service of the production assisting program. For example, the use assistance processing unit 324 selects a user and selects a production assisting program to be recommended to the user. The use assistance processing unit 324 acquires production management data corresponding to the selected user from the data accumulation server 200 via the data acquisition unit 323 and specifies a measurement item measured by the production management server 110 of the user based on the acquired data. At the same time, the use assistance processing unit 324 extracts indispensable measurement items which are used when the selected production assisting program is executed from the application management database 314. The use assistance processing unit 324 determines whether the specified measurement items include all the indispensable measurement items.

In a case where the specified measurement items include all the indispensable measurement items, the use assistance processing unit 324 notifies the user that the selected production assisting program is available. On the other hand, in a case where there is a lacking measurement item for using the selected production assisting program, the use assistance processing unit 324 notifies the user of the lacking measurement item. The use assistance processing unit 324 guides the user that the selected production assisting program can be used by newly measuring the lacking measurement item.

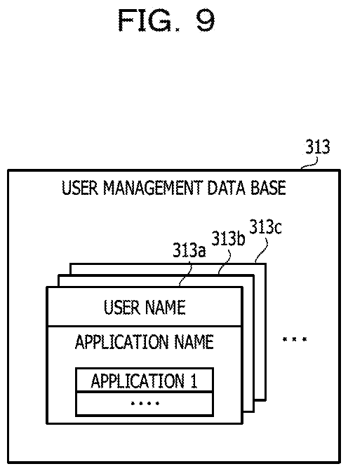

FIG. 9 is a diagram illustrating an exemplary data configuration of the user management database. The user management database 313 includes records 313a, 313b, 313c, . . . for each user. In each of the records 313a, 313b, 313c, . . . , the user name identifying the user and an application name indicating the production assisting program which can be used by the user in response to a use application from the user are registered.

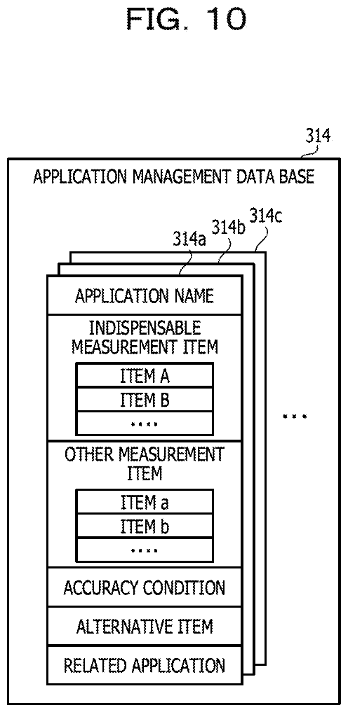

FIG. 10 is a diagram illustrating an exemplary data configuration of the application management database. The application management database 314 includes records 314a, 314b, 314c, . . . for each production assisting program. In each of the records 314a, 314b, 314c, . . . , an application name, indispensable measurement items, other measurement items, an accuracy condition, an alternative item, a related application are registered.

The application name is identification information identifying the production assisting program. The indispensable measurement item indicates a measurement item needed for the execution of the production assisting program. The other measurement item indicates a measurement item which is not included in the indispensable measurement item from among the measurement items which can be used when the production assisting program is executed. The plurality of measurement items can be registered for both of the indispensable measurement item and the other measurement item.

The accuracy condition indicates a condition of accuracy of the measurement value which can be used when the production assisting program is executed for at least one of the indispensable measurement items or the measurement items registered as other measurement items. For example, if the measurement value does not satisfy the accuracy condition, the measurement item for which the accuracy condition has been registered is not capable of being used when the production assisting program is executed. The accuracy here is an index indicating correctness and reliability of the measurement value. As the accuracy condition, for example, conditions of measurement frequency and a variation of the measurement values are registered.

The alternative item indicates other measurement item which can be used instead of the measurement item designated as the indispensable measurement item. The related application indicates an auxiliary program related to the production assisting program. For example, as the related application, an auxiliary program which can create the measurement value of the indispensable measurement item by calculation based on the measurement value of the other measurement item is registered.

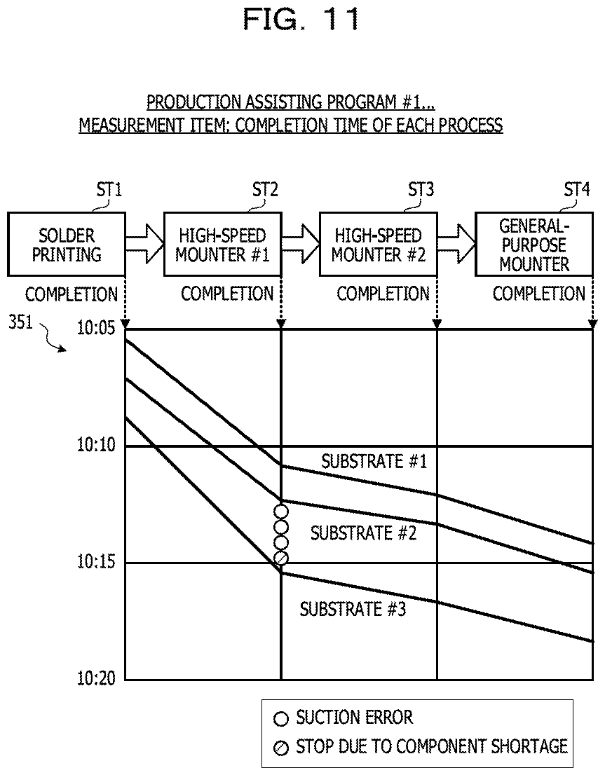

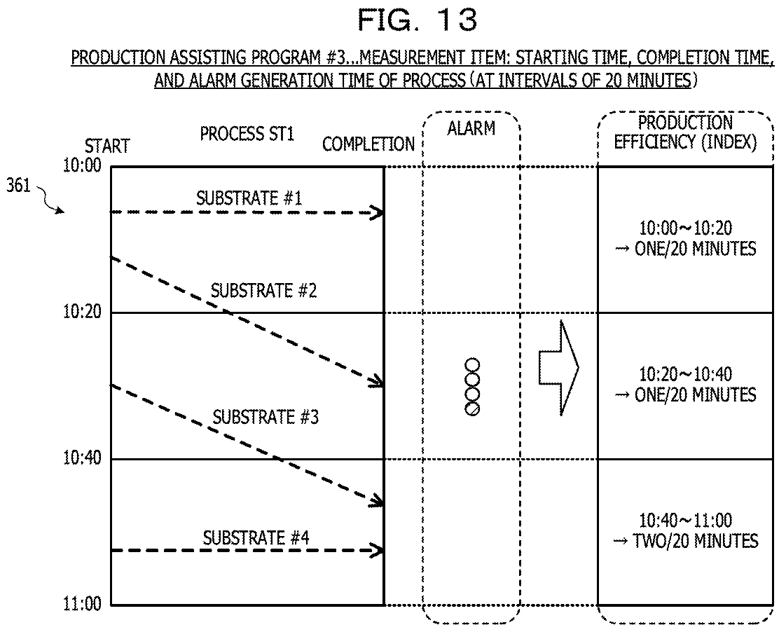

Next, a specific example of the production assisting service implemented by the production assisting program is described with reference to FIGS. 11 to 15B. In FIGS. 13 to 15B, the accuracy condition corresponding to the measurement item is exemplified.

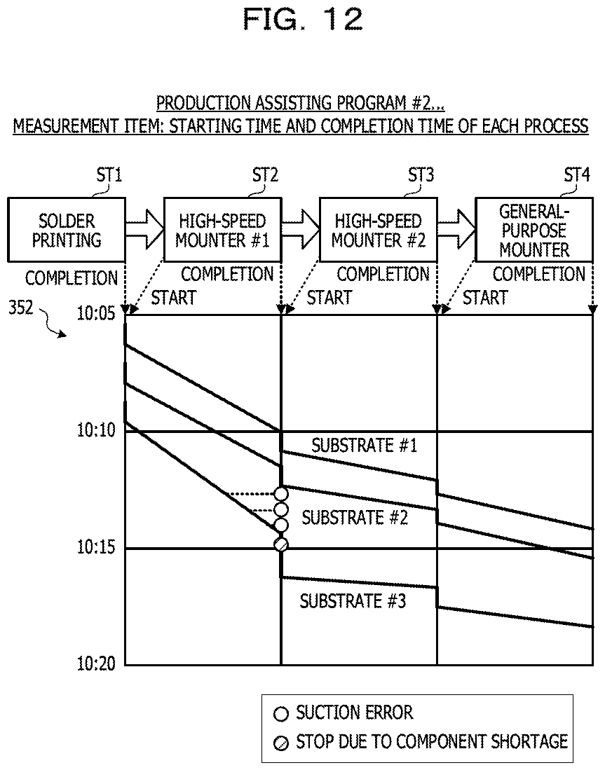

First, FIGS. 11 and 12 are diagrams illustrating exemplary processing by the production assisting program for visualizing progress results of a production process. In FIGS. 11 and 12, as an example, it is assumed that the production assisting program be applied to a mounting process of a component on a printed circuit board. It is assumed that the mounting process include processes ST1 to ST4. The process ST1 is a process for performing solder printing on the substrate. The process ST2 is a process for mounting a component on the substrate by using a high-speed mounter #1. The process ST3 is a process for mounting a component on the substrate by using a high-speed mounter #2. The process ST4 is a process for mounting a component on the substrate by using a general-purpose mounter.

FIG. 11 illustrates exemplary processing by a production assisting program #1, and FIG. 12 illustrates exemplary processing by a production assisting program #2. Although the production assisting program #2 is a program belonging to the same field as the production assisting program #1 or is a program of the same type, the production assisting program #2 has more functions than the production assisting program #1. For example, the production assisting program #2 corresponds to an upgraded version of the production assisting program #1.

As illustrated in FIG. 11, by executing the production assisting program #1, completion times of the processes ST1 to ST4 for each component are used as the measurement items, and a graph 351 illustrated in FIG. 11 is displayed on the terminal device 120 based on the completion times. The graph 351 illustrates a progress state of the processes for each of the substrates #1 to #3. The vertical axis indicates a transition of time, and the horizontal axis indicates progress in the process. The completion times of the respective processes regarding the same substrate are connected by a straight line.

According to the graph 351, it is understood that the smaller the inclination of the straight line is, the faster the progress in the process on the corresponding substrate, and the higher the production efficiency is. Therefore, the operator of the terminal device 120 can visually recognize the production efficiency in the mounting process by visually recognizing the graph 351.

As illustrated in FIG. 11, for example, it is assumed that an alarm indicating a suction error and an alarm indicating stop due to a component shortage be detected in the process ST2. The operator can estimate a substrate in which the alarm has been generated by comparing an alarm generation time and the straight line on the graph 351.

On the other hand, as illustrated in FIG. 12, when the production assisting program #2 is executed, a starting time of each of the processes ST1 to ST4 for each component is further used as the measurement item. Based on the starting time and the completion time of each process, a graph 352 illustrated in FIG. 12 is displayed on the terminal device 120. In the graph 352, a completion time of a certain process and a starting time and a completion time of the next process regarding the same substrate are sequentially connected by a straight line.

According to the graph 352, a period between the completion time of the certain process and the starting time of the next process appears as a waiting time. Therefore, the operator can recognize the production efficiency in each process from the inclination of the straight line and also recognize the length of the waiting time. The operator can confirm whether the alarm is generated when the process is executed or generated during the waiting time. In the example in FIG. 12, the operator can recognize that the alarm is generated in a waiting time between the processes ST1 and ST2 for the substrate #3. In this way, a service using the production assisting program #2 can more finely visualize the progress results of the production process than a service using the production assisting program #1.

In a record corresponding to the production assisting program #1 of the records of the application management database 314, the completion time of each process is registered as an indispensable measurement item. On the other hand, in a record corresponding to the production assisting program #2, the starting time and the completion time of each process are registered as indispensable measurement items. As the example in FIGS. 11 and 12, the production assisting program having more indispensable measurement items can provide a production assisting service which can more finely assist the production activity.

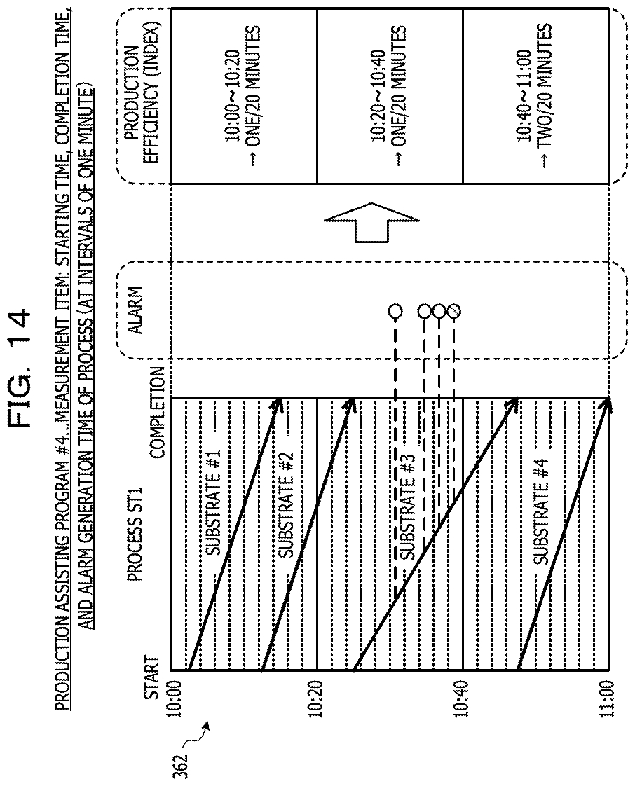

FIGS. 13 and 14 are diagrams illustrating exemplary processing by the production assisting program for visualizing a change in a production quantity per unit time. In FIGS. 13 and 14, as an example, a case is illustrated where the quantity of substrates input to the process ST1 and the quantity of substrates on which the components have been mounted in the process ST1 are visualized. FIG. 13 is exemplary processing by a production assisting program #3, and FIG. 14 is exemplary processing by a production assisting program #4. It is assumed that the production assisting program #4 correspond to an upgraded version of the production assisting program #2.

When any one of the production assisting programs #3 and #4 is executed, the starting time of the process ST1 and the completion time in the process ST1 of each substrate and the alarm generation time are used as measurement items. For example, in a record of each of the production assisting programs #3 and #4 of the records of the application management database 314, the starting time, the completion time, and the alarm generation time are registered as indispensable measurement items.

However, in the processing of the production assisting program #3, it is sufficient that an interval of acquisition of the measurement value corresponding to each measurement item be equal to or less than 20 minutes. Whereas, in the processing of the production assisting program #4, the interval of acquisition needs to be equal to or less than one minute. For example, in the record corresponding to the production assisting program #3 of the records of the application management database 314, it is registered that the acquisition interval of each of the starting time, the completion time, and the alarm generation time is equal to or less than 20 minutes as the accuracy condition. In the record corresponding to the production assisting program #4, the acquisition interval of each of the starting time, the completion time, and the alarm generation time is registered to be equal to or less than one minute as the accuracy condition. In this way, although the indispensable measurement items are the same between the production assisting programs #3 and #4, the accuracy conditions set with respect to each indispensable measurement item are different.

As illustrated in FIG. 13, by executing the production assisting program #3, a graph 361 illustrating progress of the substrates #1 to #4 in the process ST1 based on the starting time and the completion time corresponding to each of the substrates #1 to #4 is displayed on the terminal device 120. With this display, a marker indicating that the alarm is generated is displayed in association with a time zone for each 20 minutes in the graph 361 based on the alarm generation time corresponding to each of the substrates #1 to #4. The number of substrates on which the process has been performed per 20 minutes is calculated as an index indicating the production efficiency, and the calculated number is displayed in association with the time zone for 20 minutes in the graph 361. For example, in a time zone from 10:00 to 10:20, an index indicating that the number is one per 20 minutes is calculated.

On the other hand, as illustrated in FIG. 14, by executing the production assisting program #4, a graph 362 indicating progress of the substrates #1 to #4 in the process ST1 based on the starting time and the completion time corresponding to each of the substrates #1 to #4 is displayed on the terminal device 120. With this display, a marker indicating that the alarm is generated is displayed in association with a time zone for each minute in the graph 362 based on the alarm generation time corresponding to each of the substrates #1 to #4. The number of substrates on which the process has been performed per 20 minutes is calculated as an index indicating the production efficiency, and the calculated number is displayed in association with the time zone for 20 minutes in the graph 362.

According to the display information in FIG. 13, the operator can visually recognize that the alarm has been generated four times in a time zone from 10:20 to 10:30. However, both of the substrates #2 and #3 are input in the process ST1 in this time zone, the operator is not capable of determining whether the alarm is generated in which one of component mounting operations of the substrates #2 and #3. In comparison with this, according to the display information in FIG. 14, a position of the marker indicating the generation of the alarm is displayed by a finer resolution of one minute. With this display, the operator can determine that the alarm is generated in the component mounting operation of the substrate #3.

In this way, even though the indispensable measurement items used when the production assisting program is executed are the same, production assisting services having different production activity assistance levels are provided according to a difference in the accuracy conditions.

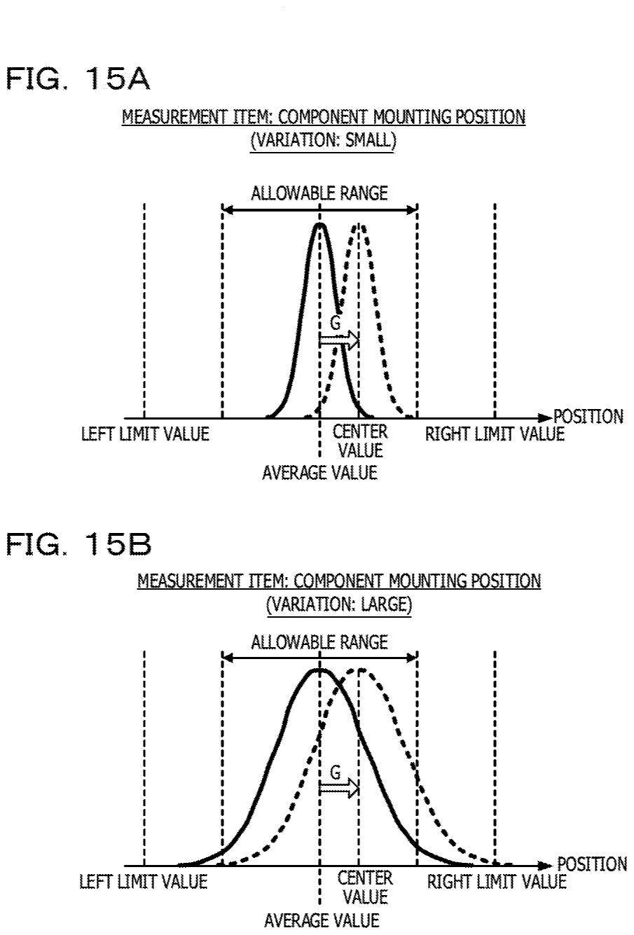

FIGS. 15A and 15B are diagrams illustrating exemplary processing by the production assisting program for correcting a displacement in a component mounting position. In FIGS. 15A and 15B, as an example, it is assumed that a production assisting program #5 be applied to a component mounting process on a substrate by a predetermined mounter. At the time when the production assisting program #5 is executed, the component mounting position on the substrate is used as an indispensable measurement item. For example, in a record corresponding to the production assisting program #5 of the records of the application management database 314, the component mounting position is registered as an indispensable measurement item. In FIGS. 15A and 15B, the component mounting position is expressed as a coordinate value in the lateral direction of the substrate, and it is assumed that the coordinate value increases as it moves to the right.

By executing the production assisting program #5, a graph illustrating distribution of mounting positions of each component input in the mounting process in a predetermined time zone is displayed on the terminal device 120. An average value of the mounting position is calculated, and a displacement amount G indicating an amount of a displacement of the average value from a predetermined reference value is calculated. The reference value indicates an ideal reference position when the component is mounted on the substrate, and the displacement amount G indicates a displacement of an average mounting position of a component in an actual mounting process from the ideal reference position.

By recognizing the calculated displacement amount G, the operator of the terminal device 120 can change control data of the production line 130 so that the component mounting position on the substrate is corrected by the displacement amount G. Alternatively, the control data of the production line 130 may be automatically corrected by the execution of the production assisting program #5.

FIG. 15A illustrates an example of a graph in a case where the variation in the mounting position is small, and FIG. 15B illustrates an example of a graph in a case where the variation is large. A range of the substrate where the component can be mounted is limited. In FIGS. 15A and 15B, a left limit value indicating a limit position on the left side and a right limit value indicating a limit position on the right side are illustrated.

In a case where the variation in the mounting position is relatively small as in FIG. 15A, even when the mounting position is moved by the displacement amount G, coordinates of the mounting position measured after the movement falls between the left limit value and the right limit value. However, even if the calculated displacement amount G is the same as that in a case of FIG. 15A, when the mounting position is moved by the displacement amount G in a case where the variation in the mounting position is large as in FIG. 15B, there is a case where the mounting position measured after the movement exceeds a range where the component can be mounted. In the example in FIG. 15B, the coordinates of the mounting position exceeds the right limit value after the mounting position has been moved.

Therefore, variation in the measurement value of the component mounting position used when the production assisting program #5 is executed needs to be equal to or less than a certain value. Therefore, in a record corresponding to the production assisting program #5 of the records of the application management database 314, it is registered that an index indicating the variation is equal to or less than a predetermined value as the accuracy condition regarding the component mounting position. For example, in FIGS. 15A and 15B, an allowable range centered on the average value of the measured component mounting positions is set. As the accuracy condition regarding the component mounting position, it is registered that dispersion of the measurement values of the mounting position falls within the allowable range.

In the examples in FIGS. 13 and 14, as the accuracy condition corresponding to the measurement item, a condition related to a measurement condition such as the acquisition interval (acquisition frequency) of the measurement value is set. Such a measurement condition is set as the measurement condition in the record of the production management database 212. Therefore, it is sufficient that the use assistance processing unit 324 determine whether or not the measurement value regarding the measurement item can be used when the production assisting program is extracted according to whether or not the measurement condition extracted from the record corresponding to the user satisfies the accuracy condition.

Whereas, in the example in FIGS. 15A and 15B, the variation in the measurement values regarding the measurement item is set as the accuracy condition. In such a case, the use assistance processing unit 324 may determine whether or not the measurement value regarding this measurement item can be used when the production assisting program is executed as follows. For example, the use assistance processing unit 324 calculates the variation in the measurement values extracted from the plurality of records corresponding to the user and makes determination according to whether or not the calculated variation satisfies the accuracy condition.

Next, the alternative item registered in the application management database 314 is described.

As described above, when determining whether or not a certain user can use a certain production assisting program, the use assistance processing unit 324 acquires production management data corresponding to the user from the data accumulation server 200. The use assistance processing unit 324 specifies the measurement items measured by the production management server 110 of the user based on the acquired data. At the same time, the use assistance processing unit 324 extracts an indispensable measurement item regarding this production assisting program from the application management database 314 and determines whether the specified measurement items include all the indispensable measurement items.

Even in a case where there is a lacking measurement item to use the production assisting program, there is a case where a measurement value of the measurement item can be substituted with a measurement value of other measurement item having almost the same measurement content. If the measurement item which can be substituted is measured by the production management server 110 of the user, the use assistance processing unit 324 can determine that the user can use this production assisting program.

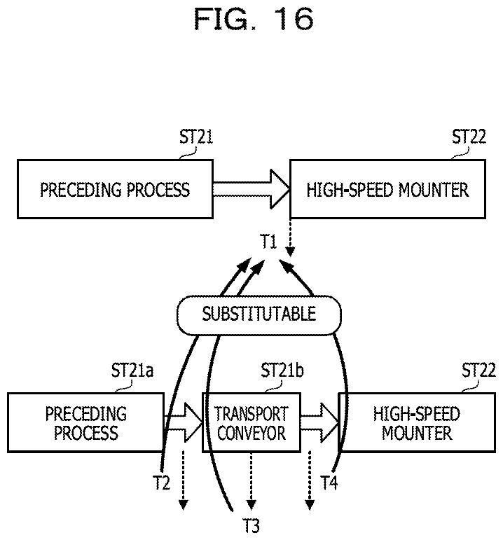

FIG. 16 is a diagram illustrating an example of the alternative item. In FIG. 16, processes ST21 and ST22 included in the mounting process of the component on the printed circuit board are assumed. The process ST21 is a preceding process of the component mounting process, and the process ST22 is a component mounting process by the high-speed mounter.

For example, a starting time T1 of the substrate to the process ST22 is set as an indispensable measurement item corresponding to a certain production assisting program. However, it is assumed that the starting time T1 be not measured by a production management server 110 of a certain user. On the other hand, as illustrated on a lower side in FIG. 16, the process ST21 includes a preceding process ST21a and a process ST21b in which the substrate is conveyed to the high-speed mounter by a transport conveyor. It is assumed that the production management server 110 of the user measure a completion time T2 of the process ST21a, a substrate passing time T3 at a predetermined position in the process ST21b, and a setting completion time T4 of the substrate by the transport conveyor in the process ST21b as measurement items.

In this case, for example, when a conveyance time of the substrate by the transport conveyor in the process ST21b is sufficiently shorter than the time needed to mount the component by the high-speed mounter in the process ST22, the starting time T1 can be substituted by any one of the completion time T2, the passing time T3, and the setting completion time T4.

Next, processing in the use assisting service of the production assisting program is described with reference to the flowchart.

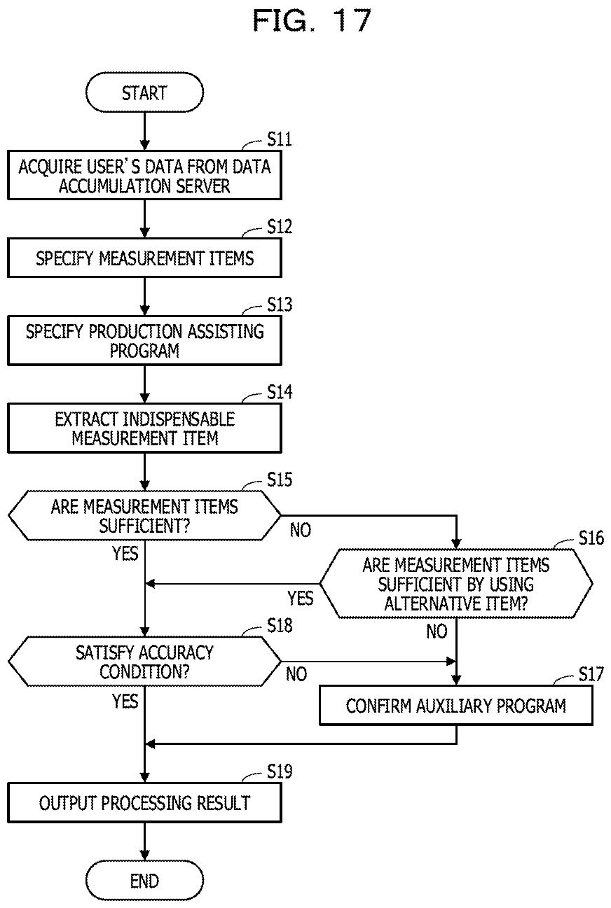

FIG. 17 is a flowchart illustrating first exemplary processing in the use assisting service. The first exemplary processing indicates processing in a use assisting service for providing information based on the determination result acquired by determining whether or not a specific user can use a specific production assisting program to the user.

[Step S11]

The use assistance processing unit 324 of the production assisting server 300 selects a user to whom the use assisting service is provided. The use assistance processing unit 324 acquires production management data corresponding to the selected user from the data accumulation server 200 via the data acquisition unit 323. For example, the use assistance processing unit 324 notifies a user name of the user selected as a search key. The use assistance processing unit 324 transmits the notified user name to the data accumulation server 200 as the search key and requests to search the production management database 212. In response to this request, a record corresponding to the user is read from the production management database 212 and is transmitted to the production assisting server 300. The data acquisition unit 323 receives data of the transmitted record and transfers the data to the use assistance processing unit 324.

[Step S12]

The use assistance processing unit 324 specifies measurement items measured by the production management server 110 of the user based on the acquired production management data. For example, the use assistance processing unit 324 extracts a measurement item set in the acquired record.

[Step S13]

The use assistance processing unit 324 specifies a single production assisting program recommended to the user. For example, in a case where the user does not receive the production assisting service yet, the use assistance processing unit 324 selects a production assisting program related to a business type of the user and an usage. In a case where the user has already received the production assisting service, for example, the following processing is executed. The use assistance processing unit 324 extracts a single production assisting program which is used by the user with reference to the user management database 313. The use assistance processing unit 324 specifies other production assisting program related to the extracted production assisting program, for example, an upgraded-version production assisting program of the extracted production assisting program as a production assisting program to be recommended to the user.

In step S13, for example, the user may designate the production assisting program. In this case, the user can inquire of the production assisting server 300 whether the specific production assisting program can be used by using a measurement value of a measurement item which is currently measured.

[Step S14]

The use assistance processing unit 324 extracts an indispensable measurement item set to the production assisting program specified in step S13 from the application management database 314.

[Step S15]

The use assistance processing unit 324 determines whether or not the measurement items of the user are sufficient by collating the indispensable measurement item extracted in step S14 with the measurement item specified in step S12.

In a case where all the extracted indispensable measurement items are included in the measurement items specified in step S12, the use assistance processing unit 324 determines that the measurement items are sufficient and executes processing in step S18. On the other hand, in a case where the indispensable measurement item which is not included in the measurement items specified in step S12 is included in the extracted indispensable measurement items, the use assistance processing unit 324 determines that the measurement item is not sufficient, and executes processing in step S16.

[Step S16]

The use assistance processing unit 324 extracts an alternative item set to the production assisting program specified in step S13 from the application management database 314. The use assistance processing unit 324 determines whether or not the following conditions are satisfied.

The use assistance processing unit 324 first determines whether the alternative item can be extracted from the application management database 314. In a case where the alternative item can be extracted, the use assistance processing unit 324 specifies the indispensable measurement item which is not included in the measurement items specified in step S12 from among the indispensable measurement items and determines whether the alternative items are set to all the specified indispensable measurement items. In a case where the alternative items have been set, the use assistance processing unit 324 determines whether all the set alternative items are included in the measurement items specified in step S12.

In a case where all the above conditions are satisfied, the use assistance processing unit 324 determines that the measurement items are sufficient by using the alternative items and executes processing in step S18. On the other hand, in a case where at least one of the above conditions is not satisfied, the use assistance processing unit 324 determines that the measurement items are not sufficient and executes processing in step S17.

[Step S17]

The use assistance processing unit 324 extracts a related application set to the production assisting program specified in step S13 from the application management database 314. The use assistance processing unit 324 confirms whether the program extracted as the related application includes an auxiliary program which can create the measurement value of the indispensable measurement item which has been determined insufficient from the measurement value of the other measurement item specified in step S12. In a case where it is determined in this processing that the auxiliary program is included, the processing result output in step S19 includes information indicating this auxiliary program.

[Step S18]

The use assistance processing unit 324 extracts an accuracy condition set to the production assisting program specified in step S13 from the application management database 314. The use assistance processing unit 324 determines whether the following condition is satisfied.

The use assistance processing unit 324 first determines whether the accuracy condition can be extracted from the application management database 314. In a case where the accuracy condition can be extracted, the use assistance processing unit 324 determines whether the measurement values of the user corresponding to all the indispensable measurement items to which the accuracy conditions are set satisfy the accuracy conditions. In a case where it is determined in step S16 that there is the alternative item corresponding to the indispensable measurement item, it is determined whether the measurement value of the user corresponding to the alternative item satisfies the accuracy condition.

In a case where all the above conditions are satisfied, the use assistance processing unit 324 determines that the user can use the production assisting program specified in step S13 and executes processing in step S19. On the other hand, in a case where at least one of the above conditions is not satisfied, the use assistance processing unit 324 executes the processing in step S17.

There are a case where the accuracy of the measurement value can be acquired from the measurement condition of the record acquired in step S11 and a case where the accuracy of the measurement value is not capable of being acquired. For example, in a case of the production assisting program #4 illustrated in FIG. 14, the indispensable measurement items are the starting time and the completion time of the process and the alarm generation time, and the accuracy condition is that the acquisition interval of these measurement values is equal to or less than one minute. In this case, in a case where the acquisition interval of each indispensable measurement item is set to the measurement condition of the record acquired in step S11, the use assistance processing unit 324 can determine whether the accuracy condition is satisfied based on the set acquisition interval.

On the other hand, for example, in a case of the production assisting program #5 illustrated in FIGS. 15A and 15B, the indispensable measurement item is the component mounting position, and the accuracy condition is that the index indicating the variation in the mounting position (here, dispersion) is equal to or less than a certain value. In this case, in a case where the dispersion of the mounting position is not set to the measurement condition of the record acquired in step S11, the use assistance processing unit 324 calculates the dispersion of the measurement values of each acquired record and determines whether the calculated dispersion satisfies the accuracy condition.

[Step S19]

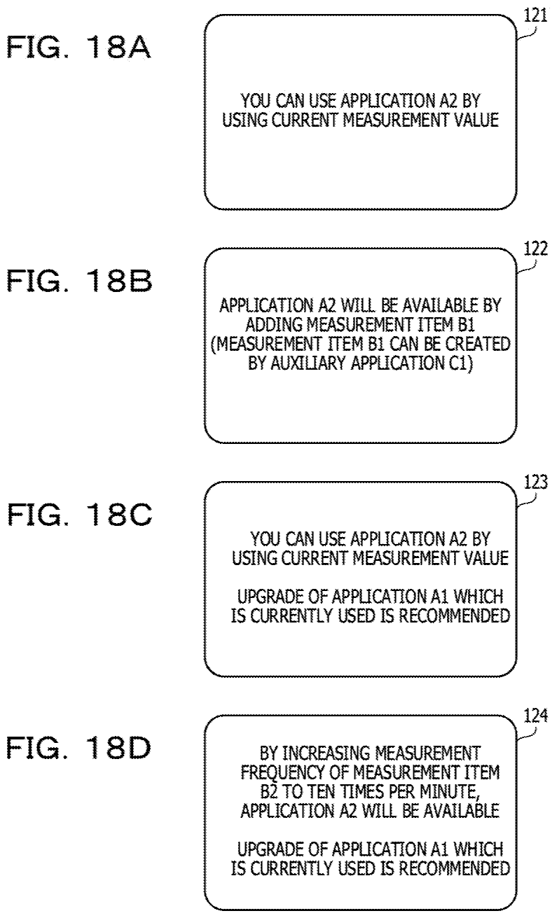

The use assistance processing unit 324 transmits the processing result of the above processing to the production management server 110 of the user and makes the terminal device 120 display the processing result. An example of the processing result is illustrated in FIGS. 18A to 18D.

FIGS. 18A to 18D are diagrams illustrating exemplary screen displays of the terminal device in the first exemplary processing. First, FIGS. 18A and 18B illustrate examples of screens presented to the user who does not receive the production assisting service.

A screen 121 illustrated in FIG. 18A is an example of a screen in a case where it is determined in step S18 in FIG. 17 that the user can use a production assisting program called “application A2”. With this screen 121, the use assistance processing unit 324 can guide the user that the user can use the production assisting program by using the measurement value which is currently measured and can recommend the use of the production assisting program. For example, the use assistance processing unit 324 can present the production assisting program that matches the production equipment of the user and environment of a production system to the user.

A screen 122 illustrated in FIG. 18B is an example of a screen in a case where it is determined in step S15 in FIG. 17 that a measurement item B1 lacks and an auxiliary program called “auxiliary application C1” which creates the measurement item B1 is extracted in step S17. With this screen 122, the use assistance processing unit 324 can guide the user that the user can use the production assisting program by newly measuring the measurement item B1 and can recommend to use the production assisting program. The use assistance processing unit 324 can guide the auxiliary program which creates the measurement value of the lacking measurement item B1 to the user and can recommend to use the above production assisting program.

In the processing for creating the information as illustrated in FIGS. 18A and 18B, the determination is made by using the accuracy condition and the alternative item. With this processing, correctness of the information to be provided can be improved.

The production assisting server 300 can promote to use the production assisting program by guiding the available production assisting program and a method for making the production assisting program be available to the user. The production assisting server 300 analyzes a large amount of production management data accumulated on the user's side and provides the information to the user as the analysis result. With this operation, the provider of the production assisting service can easily recommend to use the production assisting program to many users based on a large amount of data which is not capable of being manually analyzed. Therefore, the use of the production assisting program can be promoted at low cost.

Next, FIGS. 18C and 18D illustrate a case where the user is currently using a production assisting program called “application A1” and a production assisting program called “application A2” which is the upgraded version of the production assisting program is specified in step S13 in FIG. 17.

A screen 123 illustrated in FIG. 18C is an example of a screen in a case where it is determined in step S18 in FIG. 17 that the user can use the new production assisting program called “application A2”. With this screen 123, the use assistance processing unit 324 can guide the user that the user can use the new production assisting program and can recommend to use the production assisting program.

A screen 124 illustrated in FIG. 18D is an example of a screen in a case where it is determined in step S18 in FIG. 17 that a measurement value of a measurement item B2 which is the indispensable measurement item does not satisfy the accuracy condition that measurement frequency is equal to or more than 10 times per minute. With this screen 124, the use assistance processing unit 324 can guide the user that the new production assisting program can be used by increasing the measurement frequency of the measurement item B2 and can recommend to use the production assisting program.

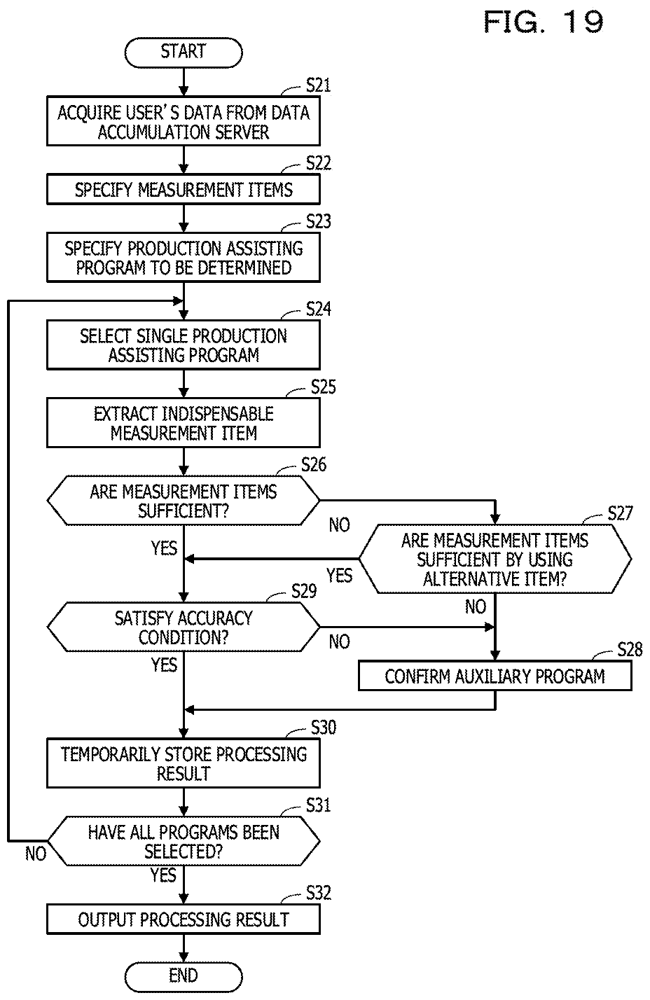

FIG. 19 is a flowchart illustrating second exemplary processing in the use assisting service. The second exemplary processing indicates processing in a use assisting service for the purpose of extracting the production assisting program which can be used by the specific user from among the plurality of production assisting programs and presenting the extracted program to the user.

[Step S21]

The use assistance processing unit 324 selects a user to whom the service is provided according to a procedure similar to step S11 in FIG. 17 and acquires production management data corresponding to the selected user from the data accumulation server 200 via the data acquisition unit 323.

[Step S22]

The use assistance processing unit 324 specifies a measurement item measured by the production management server 110 of the user according to the procedure similar to step S12 in FIG. 17.

[Step S23]

The use assistance processing unit 324 specifies one or more production assisting programs to be determined in step S24 and subsequent steps from among the production assisting programs. For example, the use assistance processing unit 324 designates an attribute so as to specify a production assisting program corresponding to the attribute. As the attribute, for example, an attribute is considered which indicates what kind of technology the production assisting program is applied or what kind of effect is caused by executing the production assisting program.

In this step S22, in a case where the user has been already received the production assisting service, a production assisting program other than the production assisting program which is currently used by the user is specified based on the user management database 313.

[Step S24]

The use assistance processing unit 324 selects a single production assisting program to be processed from among the production assisting programs specified in step S23.

[Steps S25 to S29]

The use assistance processing unit 324 executes the processing similar to the processing in steps S14 to S18 in FIG. 17 on the production assisting program selected in step S24.

[Step S30]

The use assistance processing unit 324 makes the storage region temporarily store the processing results in steps S24 to S29. The processing results indicate whether the user can use the production assisting program selected in step S24. In a case where the production assisting program is not capable of being used, the processing results indicate whether the user can use the production assisting program selected in step S24 by adding the measurement item or improving the accuracy of the measurement value of the indispensable measurement item. In a case where the measurement items are not sufficient, the processing result indicates whether the auxiliary program for creating the measurement value of the measurement item exists.

[Step S31]

The use assistance processing unit 324 determines whether all the production assisting programs specified in step S23 have been selected as processing targets. In a case where all the production assisting programs have been selected, the use assistance processing unit 324 executes processing in step S32. On the other hand, in a case where there is a production assisting program which has not been selected, the use assistance processing unit 324 executes the processing in step S24 and selects the production assisting program which has not been selected.

[Step S32]

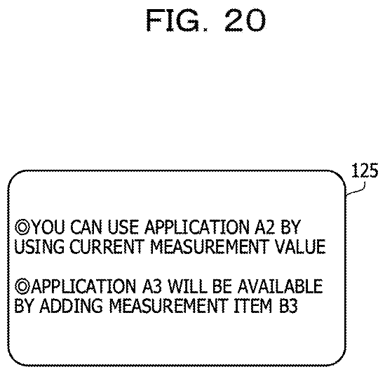

The use assistance processing unit 324 creates a final processing result based on the processing results stored in step S30, transmits the processing result to the production management server 110 of the user, and makes the terminal device 120 display the processing result. An example of the processing result is illustrated in FIG. 20.

FIG. 20 is a diagram illustrating an exemplary screen display of the terminal device in the second exemplary processing. A screen 125 illustrated in FIG. 20 indicates that the user can use the production assisting program called “application A2” by using the measurement item which is currently measured. By providing such information to the user, it is possible to present the production assisting program which matches the production equipment of the user and the environment of the production system to the user. The screen 125 indicates that another production assisting program called “application A3” can be used by newly measuring a measurement item B3. By providing such information to the user, it is possible to promote to use the production assisting program.

### Third Embodiment

In the second embodiment described above, it is determined whether the user can use the production assisting program based on the indispensable measurement item which has been registered in the application management database 314 in advance. However, not all the indispensable measurement items which have been registered in advance are not necessarily referred when the production assisting program is actually executed. In that case, in a case where the production management server 110 of the user does not measure the measurement value of the indispensable measurement item which is not actually used, it is determined that the user is not capable of using the production assisting program. Therefore, the production assisting program that has a high possibility that the production assisting program can be actually used is not capable of being provided to the user, and an opportunity for the user to use the production assisting program is lost. Therefore, both the service provider and the user have disadvantages.

Therefore, in the third embodiment, the processing of the production assisting server 300 according to the second embodiment is modified as follows. A production assisting server according to the third embodiment accumulates history information regarding used measurement items at the time when the production assisting program is executed. When recommending a certain production assisting program to the user, the production assisting server determines whether the user can use this production assisting program by using the measurement item which has been actually used from the history information as the indispensable measurement item.

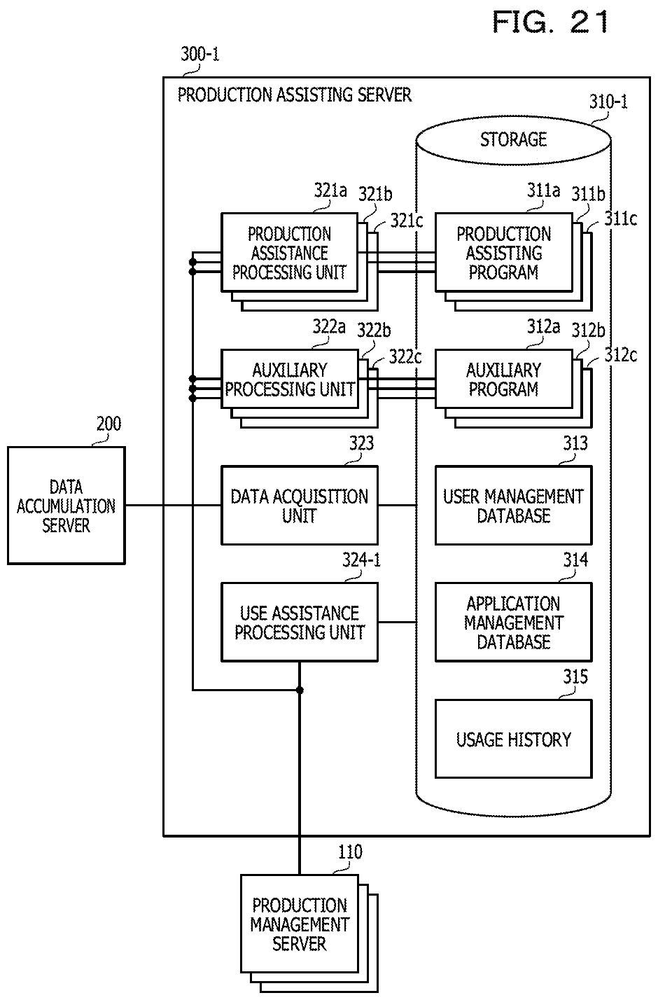

FIG. 21 is a diagram illustrating an exemplary configuration of a processing function of the production assisting server according to the third embodiment. In FIG. 21, a component same as that in FIG. 8 is denoted by the same reference numeral.

A production assisting server 300-1 illustrated in FIG. 21 includes a storage 310-1 instead of the storage 310 in FIG. 8. The storage 310-1 stores a usage history 315 in addition to the information stored in the storage 310. In the usage history 315, a history of the measurement item used (for example, referred) by production assistance processing units 321a, 321b, 321c, . . . at the time when production assisting programs 311a, 311b, 311c, . . . are executed is registered.

The production assisting server 300-1 includes a use assistance processing unit 324-1 instead of the use assistance processing unit 324 in FIG. 8. The use assistance processing unit 324-1 determines the indispensable measurement item corresponding to the production assisting program based on the usage history 315 and determines whether the user can use the production assisting program by using the determined indispensable measurement item.

Processing of the use assistance processing unit 324-1 is realized, for example, by executing a predetermined program by a processor included in the production assisting server 300-1.

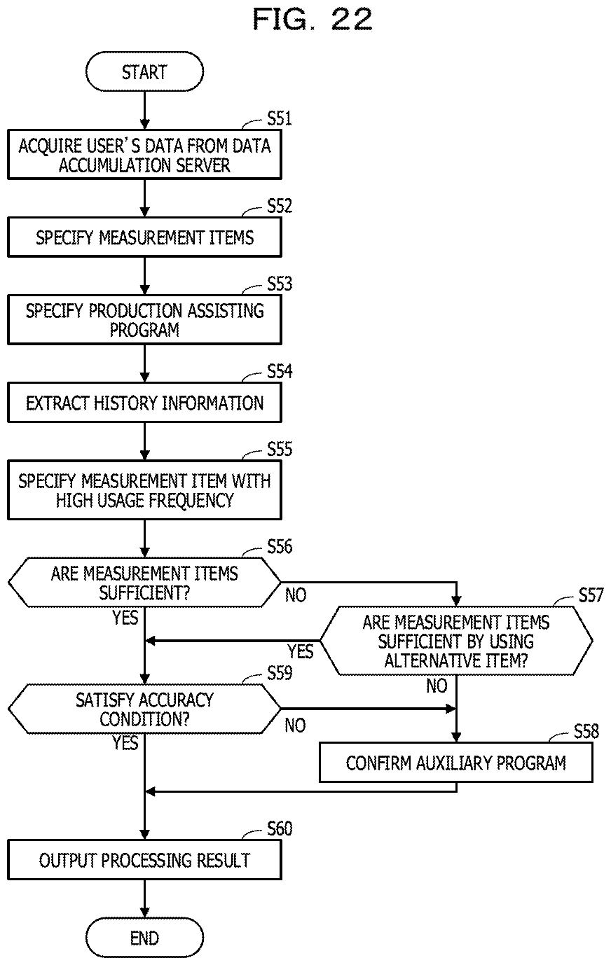

FIG. 22 is a flowchart illustrating exemplary processing in a production assisting service.

[Steps S51 to S53]

The use assistance processing unit 324-1 executes processing similar to the processing in steps S11 to S13 in FIG. 17.

[Step S54]

The use assistance processing unit 324-1 extracts history information registered when the production assisting program specified in step S53 is executed from the usage history 315. In this processing, the history information registered when a production assisting service is provided to other user is extracted.

[Step S55]

Based on the extracted usage history, the use assistance processing unit 324-1 specifies a measurement item of which usage frequency is equal to or more than a certain value from among the used measurement items as an indispensable measurement item.

This step S55 may be skipped. In this case, the indispensable measurement items to be used in steps S56 to S59 are all the measurement items included in the history information extracted in step S54.

[Step S56 to S59]

The use assistance processing unit 324-1 executes processing similar to the processing in steps S15 to S18 in FIG. 17 by using the indispensable measurement items specified in step S55.

[Step S60]

According to a procedure similar to that in step S19 in FIG. 17, the use assistance processing unit 324-1 transmits the processing result of the processing described above to the production management server 110 of the user and makes the terminal device 120 display the processing result.

According to the third embodiment described above, it is determined whether the user can use the production assisting program or how to use the production assisting program by using the measurement item which has been actually used when the production assisting program is executed as an indispensable measurement item. With this operation, it is possible to accurately make determination suitable for an actual usage of the measurement value.

### Fourth Embodiment

As described above, all the indispensable measurement item which has been registered in the application management database 314 in advance are not necessarily referred when the corresponding production assisting program is actually executed. Conversely, there may be a case where a measurement item exists which is actually used at high frequency and is considered useful to set the measurement item as an indispensable measurement item in the measurement items set as other measurement items.

Therefore, in the fourth embodiment, the following developer assisting service to a developer of the production assisting program is provided. In this service, an unnecessary measurement item of the indispensable measurement items set to the production assisting program and a measurement item to be newly added as the indispensable measurement item are notified to the developer based on the actual use state of the production assisting program.

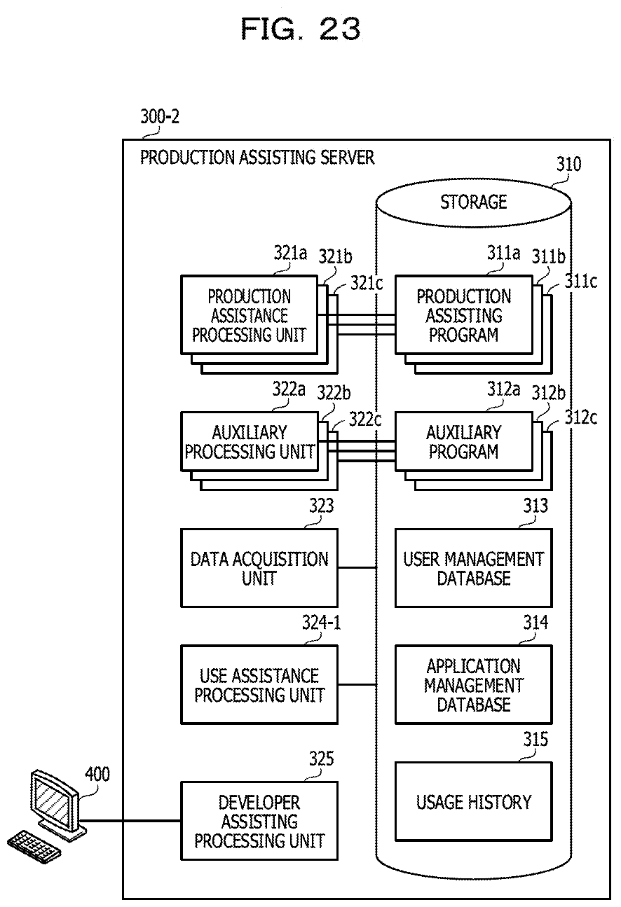

FIG. 23 is a diagram illustrating an exemplary configuration of a processing function of a production assisting server according to the fourth embodiment. In FIG. 23, a component same as that in FIG. 21 is denoted by the same reference numeral.

A production assisting server 300-2 illustrated in FIG. 23 further includes a developer assisting processing unit 325 in addition to the processing function of the production assisting server 300-1 in FIG. 21. The developer assisting processing unit 325 is connected to a developer terminal 400 which is operated by the developer of the production assisting program. The developer assisting processing unit 325 extracts history information registered when a certain production assisting program is executed from usage history 315 and calculates usage frequency of the measurement item based on the extracted history information. The developer assisting processing unit 325 determines whether an unnecessary measurement item is not included in the indispensable measurement items set to the production assisting program or whether there is no measurement item to be added as an indispensable measurement item based on the calculated usage frequency. The developer assisting processing unit 325 transmits the determination result to the developer terminal 400 and notifies the developer of the content of the determination result.

Processing of the developer assisting processing unit 325 is realized, for example, by executing a predetermined program by a processor included in the production assisting server 300-2.

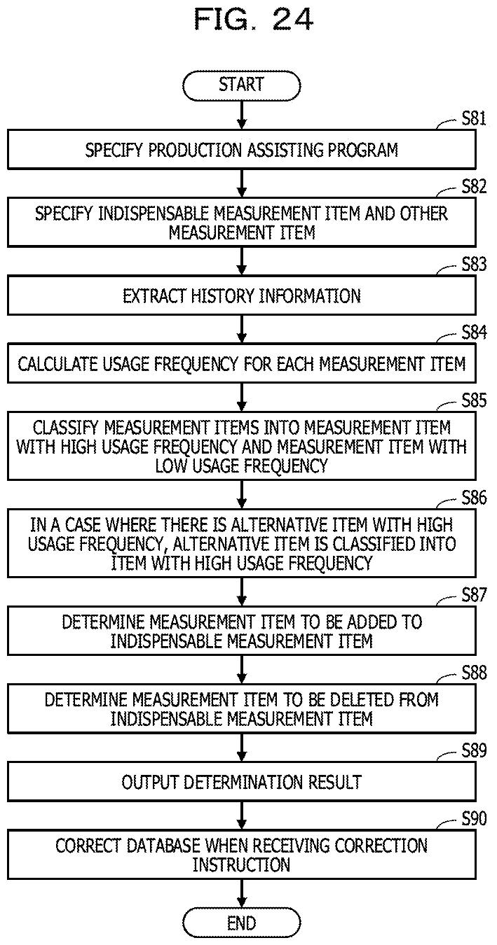

FIG. 24 is a flowchart illustrating exemplary processing in a developer assisting service.

[Step S81]

The developer assisting processing unit 325 specifies a production assisting program to be processed.

[Step S82]

The developer assisting processing unit 325 specifies indispensable measurement items set to the production assisting program specified in step S81 and other measurement items with reference to the application management database 314.

[Step S83]

The developer assisting processing unit 325 extracts history information registered when the production assisting program specified in step S81 is executed from the usage history 315.

[Step S84]

Based on the extracted history information, the developer assisting processing unit 325 specifies a measurement item which is used when the production assisting program specified in step S81 is executed. The developer assisting processing unit 325 calculates usage frequency of each specified measurement item. For example, the usage frequency is calculated by dividing the number of times when measurement data of the measurement item is referred by a time when the production assisting program is executed.

[Step S85]

The developer assisting processing unit 325 classifies the measurement items specified in step S84 into measurement items with high usage frequency and measurement items with low usage frequency. The classification is performed by comparing the usage frequency with a predetermined threshold. In a case where the usage frequency is equal to or higher than the threshold, it is determined that the usage frequency is high, and in a case where the usage frequency is less than the threshold, it is determined that the usage frequency is low.

[Step S86]

With reference to the application management database 314, the developer assisting processing unit 325 extracts a measurement item to which an alternative item is set from among the measurement items which is determined that the usage frequency is low in step S85. In a case where the measurement item to which the alternative item is set is extracted and usage frequency of the set alternative item exceeds the threshold, the developer assisting processing unit 325 classifies the measurement items into the measurement item with high usage frequency again.

According to the processing in step S86, even in a case where actual usage frequency of the measurement item which is set as an indispensable measurement item is low, in a case where the usage frequency of the corresponding alternative item is high, the original measurement item is maintained to be the indispensable measurement item.

[Step S87]

The developer assisting processing unit 325 extracts a measurement item which is not included in the indispensable measurement items specified in step S82 from among the measurement items which have been determined that the usage frequency is high in steps S85 and S86. The developer assisting processing unit 325 determines the extracted measurement item as a measurement item to be added to the indispensable measurement item.

[Step S88]

The developer assisting processing unit 325 extracts the measurement item which is determined that the usage frequency is low in steps S85 and S86 from among the indispensable measurement items specified in step S82. The developer assisting processing unit 325 determines the extracted measurement item as a measurement item to be deleted from the indispensable measurement items.

[Step S89]

The developer assisting processing unit 325 transmits the determination results in steps S87 and S88 to the developer terminal 400 and makes the developer terminal 400 display the determination results.

[Step S90]

In a case where the developer terminal 400 requests to correct the application management database 314 in response to the operation of the developer, the developer assisting processing unit 325 corrects the application management database 314 based on the determination results in steps S87 and S88.

For example, the developer assisting processing unit 325 specifies a record corresponding to the production assisting program specified in step S81 from among records of the application management database 314. The developer assisting processing unit 325 deletes the measurement item which has been determined to be deleted in step S88 from the indispensable measurement items registered in the specified record and adds the measurement item as other measurement item. The developer assisting processing unit 325 adds the measurement item determined to be added in step S87 to the specified record as an indispensable measurement item and deletes the measurement item from the other measurement items.

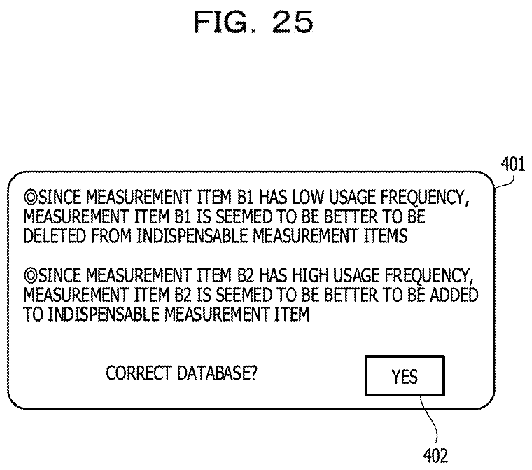

FIG. 25 is a diagram illustrating an exemplary screen display of a developer terminal by a developer assisting service. A screen 401 illustrated in FIG. 25 indicates a case where the measurement item B1 has been determined to be deleted from the indispensable measurement items in step S88 in FIG. 24 and the measurement item B2 has been determined to be added as an indispensable measurement item in step S87. According to this screen 401, the measurement item to be deleted from the indispensable measurement items and the measurement item to be added to as the indispensable measurement item are notified to the developer as analysis results of a data use state at the time when the production assisting program is executed. The developer can utilize the notified information at the time of development of the production assisting program in the future and maintenance of the current production assisting service. Therefore, according to the processing of the developer assisting processing unit 325, it is possible to improve a development efficiency and a maintenance work efficiency by the developer.

In the screen 401, a button 402 used for requesting to correct the application management database 314 is displayed. By performing an operation for selecting the button 402 by the developer, the production assisting server 300-2 is requested to correct the application management database 314. In response to this request, the processing in step S90 in FIG. 24 is executed, and information on the indispensable measurement item and the other measurement item among the records of the production assisting program is updated.

With this update, only the data item which is highly likely to be actually used when the production assisting program is executed is registered as an indispensable measurement item, and use conditions of the production assisting program are made appropriate so as to match an actual usage of the user. As a result, a possibility is increased that a user who can receive benefits by using the production assisting program uses the production assisting program, and the use of the production assisting program is promoted.

For example, a screen acquired by removing the button 402 from the screen 401 may be displayed on a terminal device of an administrator of the production assisting program. In this case, the administrator can perform a setting change operation of the application management database 314 based on the displayed screen.

The processing function of the device (for example, program use assisting device 1, production assisting servers 300, 300-1, and 300-2) indicated in each embodiment described above can be realized by a computer. In that case, a program in which processing content of the function to be provided in each device is written is provided and the computer executes the program so that the processing function is realized on the computer. The program in which the processing content is written can be recorded in a computer-readable recording medium. The computer-readable recording medium includes a magnetic storage device, an optical disk, a magneto-optical recording medium, a semiconductor memory, and the like. The magnetic storage device includes a hard disk drive (HDD), a flexible disk (FD), a magnetic tape, and the like. The optical disk includes a digital versatile disc (DVD), a DVD-RAM, a compact disc-read only memory (CD-ROM), a CD-recordable (R)/rewritable(RW), and the like. The magneto-optical recording medium includes a magneto-optical disk (MO) and the like.

In a case where the program is distributed, for example, a portable reading medium such as a DVD, a CD-ROM, and the like in which the program is recorded is sold. Alternatively, it is possible to store the program in a storage device of a server computer and transfer the program from the server computer to another computer via a network.

The computer which executes the program stores, for example, the program recorded in the portable reading medium or the program transferred from the server computer in a storage device of the computer. The computer reads the program from the storage device of the computer and executes processing according to the program. The computer can directly read the program from the portable reading medium and execute processing according to the program. The computer can sequentially execute processing according to the received program each time when the program is transferred from the server computer connected via the network.

The above merely describes the principle of the present invention. Numerous modifications and variations are available for those skilled in the art, the present invention is not limited to the correct configuration and application example illustrated and described above, and all corresponding variations and equivalents are regarded within the scope of the present invention by appended claims and equivalents thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program use assisting program for causing a computer to execute processing comprising:
acquiring data items included in production management data;
referring to a storage that stores a data item which is used when each of a plurality of production assisting programs is executed;
specifying a production assisting program of which all data items which are used at the time of execution are included in the acquired data items from among the plurality of production assisting programs as a specific program; and
outputting information indicating the specific program.

2. The non-transitory computer-readable recording medium according to claim 1, wherein
the acquiring includes processing to acquire the production management data,
the processing further includes processing to calculate an index value indicating accuracy of a data value corresponding to the acquired data item based on the acquired production management data, and
a condition to specify the specific program includes that the calculated index value satisfies an index value reference of accuracy which is set to the acquired data item.

3. The non-transitory computer-readable recording medium according to claim 1, wherein the processing further includes:
acquiring an index value indicating accuracy of a data value included in the production management data, corresponding to the acquired data item, wherein
a condition to specify the specific program includes that the acquired index value satisfies an index value reference of accuracy which is set to the acquired data item.

4. The non-transitory computer-readable recording medium according to claim 2, wherein
the index value indicates acquisition frequency of a data value corresponding to a same data item or a variation degree of the data value corresponding to the same data item.

5. The non-transitory computer-readable recording medium according to claim 1, wherein the processing further includes:
specifying a first program as the specific program in a case where a second data item is included in the acquired data item and all data items other than a first data item of the data items corresponding to the first program in the storage are included in data items other than the second data item of the acquired data items when the second data item which substitutes the first data item is set to the first data item which is used when the first program of the plurality of production assisting programs stored in the storage is executed and it is determined that the first data item does not coincide with the acquired data item in the specification of the specific program.

6. A non-transitory computer-readable recording medium having stored therein a program use assisting program for causing a computer to execute processing comprising:
acquiring data items included in production management data;
specifying data items which are stored in a storage and used when a production assisting program is executed;
extracting a data item which is not included in the acquired data items from among the specified data items; and
outputting output information based on the extraction result.

7. The non-transitory computer-readable recording medium according to claim 6, wherein the processing further includes:
acquiring first information for designating a specific production assisting program, wherein
the production assisting program is a production assisting program designated according to the first information.

8. The non-transitory computer-readable recording medium according to claim 6, wherein
the output information includes at least one of information indicating the extracted data item and information indicating a production management data generation program for generating a data value corresponding to the extracted data item.

9. The computer-readable recording medium having stored therein the program use assisting program according to claim 6, wherein
the storage stores data items used when each of a plurality of production assisting programs is executed, and
the output information includes information indicating a production assisting program used at the time when a first data item which is not included in the acquired data items is executed among the plurality of production assisting programs and information indicating the first data item.

10. The non-transitory computer-readable recording medium according to claim 6, wherein
the storage stores a reference value regarding accuracy of a data value with respect to each of the data items which is used when the production assisting program is executed,
the acquiring includes processing to acquire the production management data, and
in a case where an evaluation value of the accuracy of the data value included in the production management data corresponding to the first data item of the acquired data items does not satisfy the reference value stored in the storage relative to the first data item although all the specified data items are included in the acquired data items, the computer is further caused to execute processing for outputting information indicating that the production assisting program becomes available by enhancing accuracy of the data value regarding the first data item.

11. The non-transitory computer-readable recording medium according to claim 6 wherein
the storage stores a reference value regarding accuracy of a data value with respect to each of the data items which is used at the time when the production assisting program is executed,
the acquiring includes processing to acquire the production management data and an evaluation value of accuracy of a data value included in the production management data, the evaluation value corresponding to the acquired data item, and
in a case where the evaluation value corresponding to the first data item of the acquired data items does not satisfy the reference value stored in the storage relative to the first data item although all the specified data items are included in the acquired data items, the computer is further caused to execute processing for outputting information indicating that the production assisting program becomes available by enhancing accuracy of the data value regarding the first data item.

12. An information processing apparatus comprising:
a storage configured to store data items which used when each of a plurality of production assisting programs is executed; and
a processor coupled to the storage and configured to execute processing of:
acquiring data items included in production management data;
referring to the storage that stores a data item which is used when each of a plurality of production assisting programs is executed;
specifying a production assisting program of which all data items which are used at the time of execution are included in the acquired data items from among the plurality of production assisting programs as a specific program; and
outputting information indicating the specific program.
